(19) United States
(12) Patent Application Publication
(10) Pub. No.: US 2018/0309768 A1
(43) Pub. Date: Oct. 25, 2018

(54) AUTOMATED AUTHENTICATION, VALIDATION AND PROCESSING OF DIGITIZED FILES

(71) Applicant: Bank of America Corporation, Charlotte, NC (US)

(72) Inventors: Manu Jacob Kurian, Dallas, TX (US); Joseph Benjamin Castinado, North Glenn, CO (US); Victoria L. Dravneek, Charlotte, NC (US)

(21) Appl. No.: 15/492,375

(22) Filed: Apr. 20, 2017

(51) Int. Cl. H04L 29/06; G06F 21/62

(52) U.S. Cl. CPC H04L 63/126; H04L 63/08; H04L 67/10; G06F 2221/2113; G06F 21/6245

(57) ABSTRACT

Automated authentication, validation and processing of digitized files. Specifically, the invention provides for receiving/ingesting digitized files from an entity/user that include one or more sub-files (i.e., documents) that require processing. Security level(s), which define validation and processing requirements are determined for one or more of the entity/user, the sub-files and/or the intended recipients of the sub-files. The identity of the entity/user and the validation of the intended recipient and/or sub-files is/are verified in accordance with the determined security level. In response to verifying the identity of the entity/user and/or the verifying the validation of the intended recipient(s) and sub-files, the sub-files are processed according to the determined security levels.

### FIELD OF THE INVENTION

The present invention is generally related authentication and validation of identities and data and, more specifically, automated authentication, validation and processing of digital files.

### BACKGROUND

A need exists to develop systems, devices and the like that provide for the automated authentication and validation of entities and contents of digitized files and, subsequent automated processing of the contents.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a system that allows for automated, authentication and validation/verification of the contents of digitized files and the subsequent automated processing of the contents.

In this regard, a system receives a digitized file from an entity/entity inputs a digitized file into the system. The system has the capability to read the digitized file and, based on previous validation of the file and/or contents of the file determine a level of security for (i) the file and/or contents of the file, (ii) the entity and/or (iii) the intended recipient of the file. In addition, the system verifies the identity of the entity based on the security level, processes the contents of the digitized file according to the security level and initiated communication of the file and/or contents to the intended recipient.

A system for automated authentication, validation and processing of digitized files defines first embodiments of the invention. The system includes a distributed computing network and an entity database in communication with the network. The database is configured to store, in memory, a plurality of entity profiles that include attributes associated with the entity. The system additionally includes a first computing apparatus in communication with the network and including a memory and at least one processing device.

The memory of the first computing apparatus stores a digitized file processing module that is executable by the processing device(s). The digitized file processing module is configured to receive, via the distributed computing network, a digitized file that is associated with an entity and includes one or more documents requiring processing. The module is further configured to determine one or more security levels associated with at least one of (i) the entity, (ii) one or more of the documents, and/or (iii) the intended recipient(s) of the file and/or documents. The module is further configured to access the entity database, via the network, to verify the identity of the entity based on an entity profile associated with the entity including one or more attributes required by the security level. In response to verifying the identity of the entity, the module is further configured to process the one or more documents in accordance with the security level and, in response to processing the one or more documents, communicate the one or more documents to the intended recipient.

The system additionally includes a plurality of second computing apparatus that are in trusted communication the first computing apparatus, via the network. Each second computing apparatus is associated with one of a plurality of validated document recipients and configured to receive one or more documents associated with the validated document recipient.

In additional embodiments the system includes a validated document recipient database in communication with the distributed computing network and configured to store a plurality of document recipient profiles that include one or more verified documents. In such embodiments of the system, the digitized file processing module is further configured to access the validated document recipient database to verify at least one of (1) the intended recipient of the one or more documents is a validated document recipient and (2) the one or more documents are validated documents. In further related embodiments of the system, the digitized file processing module is further configured to initiate validation of a document recipient in response to a determination that the intended recipient is not currently a validated document recipient.

In still further specific embodiments of the system, the digitized file processing module is configured to process the one or more documents by accessing the entity database, via the distributed computing network, to retrieve attributes associated with entry fields in the one or more documents and insert the attributes in the entry fields. In related embodiments of the system, the digitized file processing module is further configured to determine at least one of (1) which of the one or more documents are required by the intended recipient, and (2) which of the attributes inserted in the entry fields are required by the intended recipient, and, in response to determining at least one of (1) and (2), insure that only at least one of required documents and required attributes are communicated to the intended recipient. In other related embodiments of the system, the digitized file processing module is further configured to access at least one of the entity database or an ancillary database to validate the attributes inserted in the entry fields in accordance with the security level.

In further embodiments of the system, the digitized file processing module is further configured to generate and attach to at least one of the one or more documents a virtual notarization seal, wherein the virtual notarization seal attests to at least one of (1) the identity of the entity, and (2) the validity of the attributes inserted into the entry fields.

In still further embodiments of the system, the digitized file processing module is further configured to determine that at least one of the one or more documents require recurring processing and automatically process the one or more documents on a recurring basis, wherein the recurring basis is based on a predetermined processing schedule.

In other specific embodiments of the system, the digitized file processing module is further configured to determine an amount of resources associated with the one or more documents and transfer the resources to the intended recipient.

Moreover, in additional specific embodiments the system includes an attribute update module stored in memory, executable by the at least one processing device and configured to receive one or more data feeds on an ongoing basis, wherein the data feeds include information associated with the attributes stored in the entity profiles, determine that the information reflects a change in the attributes and access the entity database to update the attributes in the entity profiles to reflect the change.

An apparatus for automated authentication, validation and processing of digitized files defines second embodiments of the invention. The apparatus includes a computing platform including a memory and at least one processing device stored in the memory. The apparatus further includes a digitized file processing module stored in the memory and executable by the least one processing device. The module is configured to receive a digitized file associated with an entity and comprising one or more documents requiring processing and determine a security level associated with at least one of the entity, the one or more documents and an intended recipient of one or more documents. The module is further configured to verify an identity of the entity, wherein a level of verification is associated with the security level and, in response to verifying the identity of the entity, process the one or more documents in accordance with the security level. In addition, the module is configured to, in response to processing the one or more documents, initiate communication of the one or more documents to the intended recipient.

In specific embodiments of the apparatus, the digitized file processing module is further configured to verify at least one of (1) the intended recipient of the one or more documents is a validated document recipient, and (2) the one or more documents are validated documents. In such embodiments of the apparatus, the digitized file processing module is further configured to initiate validation of a document recipient in response to a determination that the intended recipient is not currently a validated document recipient.

In further specific embodiments of the apparatus, the digitized file processing module is configured to process the one or more documents by retrieving attributes associated with entry fields in the one or more documents and inserting the attributes in the entry fields. In such embodiments of the apparatus, the digitized file processing module may be further configured to generate and attach to at least one of the one or more documents a virtual notarization seal, wherein the virtual notarization seal attests to at least one of (1) the identity of the entity and (2) the validity of the attributes inserted into the entry fields.

In other related embodiments of the apparatus, the digitized file processing module is further configured to determine that at least one of the one or more documents require recurring processing and automatically process the one or more documents on a recurring basis, wherein the recurring basis is based on a predetermined processing schedule.

In still further specific embodiments of the apparatus, the digitized file processing module is further configured to determine an amount of resources associated with the one or more documents and transfer the resources to the intended recipient.

A computer program product for automated authentication, validation and processing of digitized files defines third embodiments of the invention. The computer program product includes a non-transitory computer-readable medium. The medium includes a set of codes for causing at least one computer to receive a digitized file associated with an entity and comprising one or more documents requiring processing and determine a security level associated with at least one of the entity, the one or more documents and an intended recipient of one or more documents. The set of codes further cause the at least one computer to verify an identity of the entity, wherein a level of verification is associated with the security level and, in response to verifying the identity of the entity, process the one or more documents in accordance with the security level. Additionally, the set of codes cause the at least one computer to, in response to processing the one or more documents, initiate communication of the one or more documents to the intended recipient.

In other specific embodiments of the computer program product, the set of codes cause the at least one computer to verify that at least one of (1) the intended recipient of the one or more documents is a validated document recipient, and (2) the one or more documents are validated documents.

Thus, systems, apparatus, methods, and computer program products herein described in detail below provide for automated authentication, validation and processing of digitized files. Specifically, embodiments of the invention provide for receiving/ingesting digitized files from an entity/user that include one or more sub-files (i.e., documents) that require processing. Security level(s), which define validation and processing requirements are determined for one or more of the entity/user, the sub-files and/or the intended recipients of the sub-files. The identity of the entity/user and the validation of the intended recipient and/or sub-files is/are verified in accordance with the determined security level. In response to verifying the identity of the entity/user and/or the verifying the validation of the intended recipient(s) and sub-files, the sub-files are processed according to the determined security levels.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a schematic diagram of a system for automated authentication, validation and processing of digitized files, in accordance with embodiments of the present invention;

FIG. 2 provides a block diagram of an apparatus for automated authentication, validation and processing of digitized files, in accordance with embodiments of the present invention;

FIG. 3 provides a flow diagram of a method for automated, authentication, validation, and processing of digitized files, in accordance with embodiments of the present invention; and

FIG. 4-6 provide a flow diagram of a method for automated, authentication, validation and processing of digitized files, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal allocation. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Thus, embodiments of the present invention address the above needs and/or achieve other advantages by providing for automated authentication, validation and processing of digitized files. Specifically, embodiments of the invention provide for receiving/ingesting digitized files from an entity/user that include one or more sub-files (i.e., documents) that require processing. Security level(s), which define validation and processing requirements are determined for one or more of the entity/user, the sub-files and/or the intended recipients of the sub-files. The identity of the entity/user and the validation of the intended recipient and/or sub-files is/are verified in accordance with the determined security level. In response to verifying the identity of the entity/user and/or the verifying the validation of the intended recipient(s) and sub-files, the sub-files are processed according to the determined security levels.

Processing of the sub-files may entail accessing an entity database that includes entity/user profiles to retrieve entity/user attributes that correspond to entry fields in the sub-files/documents and inserting the attributes in the sub-files. Further, processing may include validating the attributes to insure their accuracy/correctness and performing quality control on the sub-file to insure that entries in entry fields have been completed. Further, processing may include generating and attaching to the sub-files/documents a virtual notarization seals that attests to at least one of the identity of the entity/user and/or the validity of the attributes. Additionally, for those sub-files/documents that require such, processing includes initiating transfer of resources to the intended recipients. Once the sub-files have been processed, the processed sub-files/documents are communicated to the intended recipients via a secure/trusted communication channel.

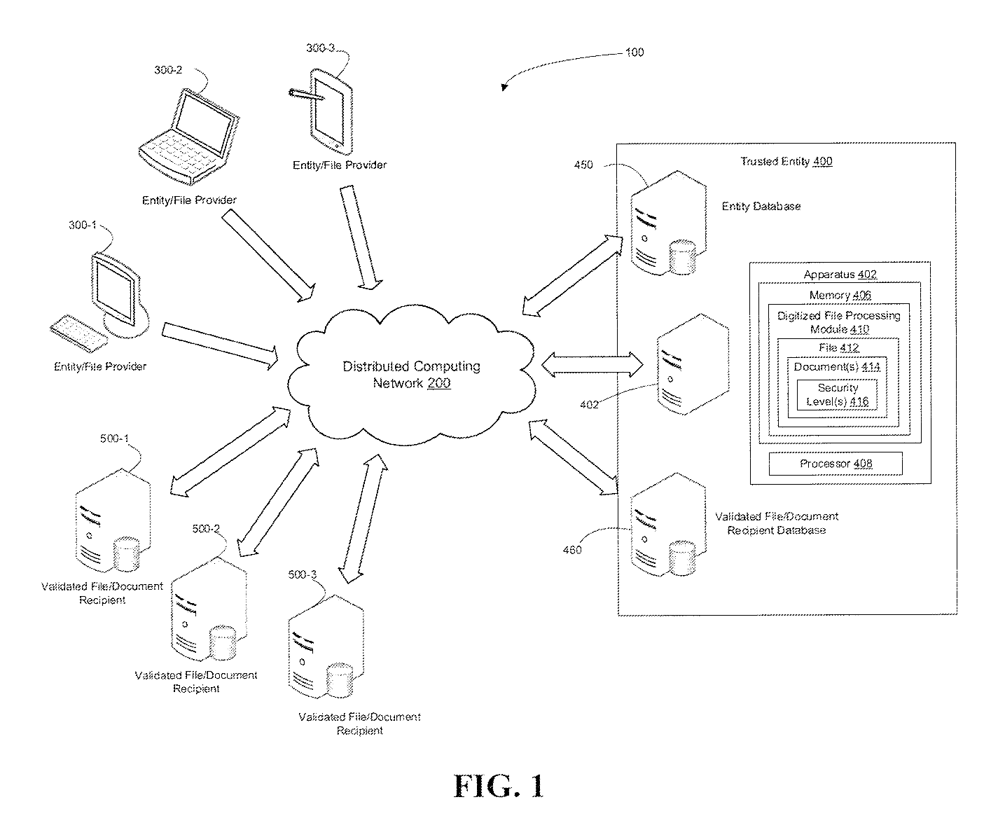

Referring to FIG. 1, a schematic diagram is shown of a system 100 for automated authentication, validation and processing, in accordance with embodiments of the present invention. The system 100 incorporates a distributed computing network 200 that is configured to allow for wireless and/or wired electronic communication of data, such as digitized files or the like. The distributed computing network 200 may comprise the Internet, an intranet and/or a combination of the Internet and an intranet.

Computing apparatus 300 are configured to provide the system with digitized files 412 that require processing. The computing apparatus 300 may be any computing device capable of interfacing with the distributed computing network 200, such as, but not limited to, a personal computer 300-1, a laptop/portable computing device 300-2 and a tablet/smart telephone device 300-3. The computing apparatus 300 is in the possession of or otherwise in the control of the entity that provides the digitized file 412 to the system. The entity, otherwise referred to herein as the user, may be an individual or a group of individuals, such as a family entity, a corporate entity or the like. The digitized file 412 includes one or more sub-files/documents 414 that require processing and submission to one or more file/document recipients. The sub-file document 414 may require verification/attestation as to the identity of the entity/user and/or transfer of resources associated with the submission of the document. For example, the digitized file 412 may include sub-files/documents 414 associated with registering an entity/user for a designated function/purpose and may require notarization/validation of the entity/user along with a transfer of resources in order for the intended sub-file/document recipient to further process the document (i.e., complete the registration process).

The system includes a trusted entity 400 that operates the automated, authentication, validation and processing of the present invention. The trusted entity 400 may be any entity that users typically entrust in terms of securing confidential or otherwise private information. For example, the trusted entity may be a government agency, a financial institution or other group or organization that entities/users have a high level of trust in. The trusted entity includes or otherwise has network access to, via the distributed computing network 200, an entity database 450 that stores entity/user profiles that include verified attributes associated with the entity/user.

The system further includes a computing apparatus 402 that comprises a memory 406 and at least one processor 408 in communication with the processor. The memory 406 stores digitized file processing module 410 that is executable by one or more of the processors 408. Digitized file processing module 410 is configured to receive/ingest digitized files transmitted, via the distributed computing network 200, by the computing apparatus 300 and read the contents of the digitized file, (i.e., read the sub-files/documents 414). The digitized file processing module 410 is configured determine at least one security level 416 associated with one or more of the entity/user, the sub-file/document 414 and/or the intended recipient. Further, the digitized file processing module is further configured to access the entity database 450, via the distributed computing network 200, to verify the identity of the entity based on the entity profile associated with the entity including one or more attributes provided by the entity and required by the security level 416.

Additionally, the trusted entity 400 includes or otherwise has access to a validated file/document recipient database 460 that stores validated recipient profiles and associated validated sub-files/documents 414 associated with the validated recipient. In this regard, the system insures that sub-file/document recipients are who they purport to be and that entity/user information is only communicated to recipients that have been validated. In addition, the system establishes a secure communication channel with validated document recipients to insure secure transmission of the sub-files/documents 414 to the validated document recipient. Thus, in response to receiving a digitized file 410, the digitized file processing module 410 is configured to access the validated file-document recipient database 460 to verify that the intended recipient of one or more of the sub-files/documents have been previously validated and/or verify that the one or more sub-files/documents have been validated/approved for processing by the system.

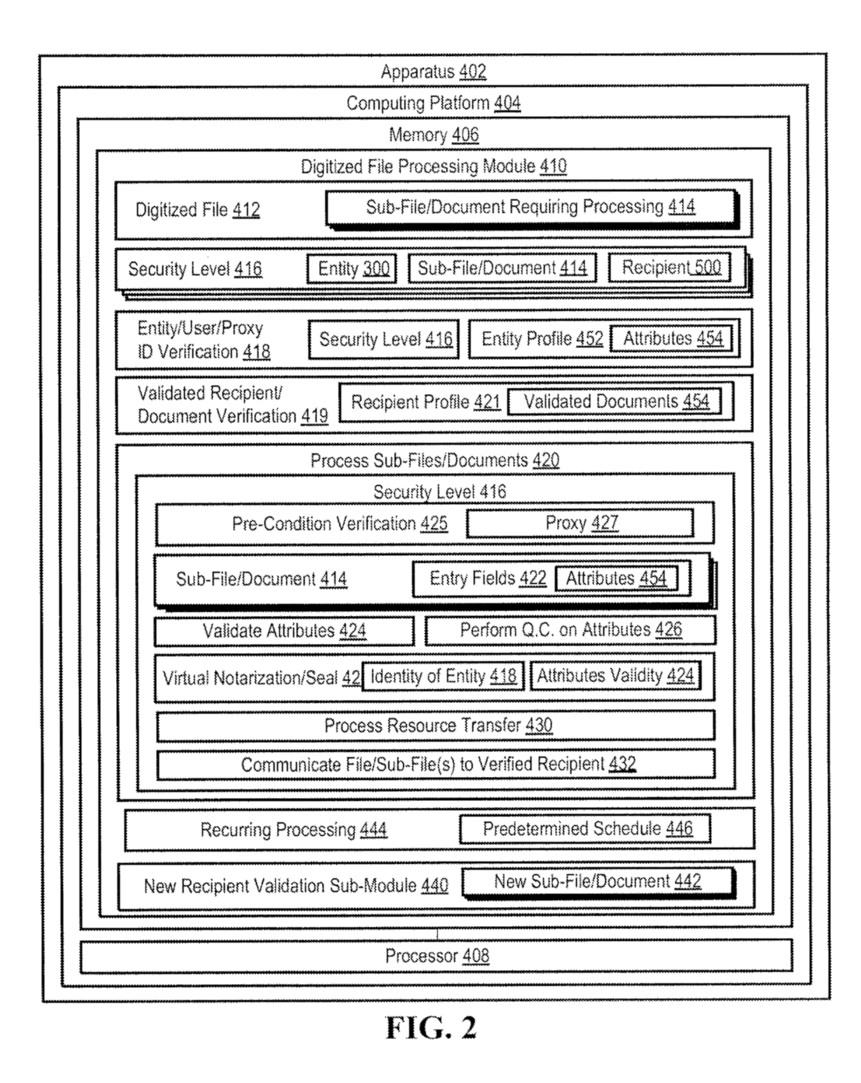

In response to verifying the entity/user and, in some, the digitized file processing module 410 is further configured to process the one or more sub-files/documents 414 in accordance with the at least one of the determined security levels 416 and, in response to processing the sub-files/documents 414, initiate communication of the sub-files/documents 414 to the intended recipients. FIG. 2, described infra. provides details as to the processing of the sub-files/documents 414. Computing apparatus 500, such as servers 500-1, 500-2, 500-3 or the like, are configured to receive the processed sub-files/documents 414. As previously noted, each computing apparatus 500 may be associated with one of a plurality of validated sub-file/document recipients, such that each computing apparatus 500 has a trusted communication channel (e.g., tunnel connection or the like) established with the trusted entity 400 for the purpose of communicating the processed sub-files/documents to the validated document recipient.

Referring to FIG. 2 a block diagram is presented of computing apparatus 402 configured for automated authentication, validation and processing of digitized files, in accordance with embodiments of the invention. Computing apparatus 402 may comprise a server device or the computing device may comprise one of the one or more other computing devices (e.g., PCs or the like) capable of processing the sub-files/documents 414. The computing apparatus 402 includes a computing platform 404 that can execute algorithms, such as modules, routines, applications and the like. Computing platform 404 includes memory 406, which may comprise volatile and non-volatile memory, such as read-only and/or random-access memory (RAM and ROM), EPROM, EEPROM, flash cards, or any memory common to computer platforms). Moreover, memory 406 may comprise cloud storage, such as provided by a cloud storage service and/or a cloud connection service.

Further, computing platform 404 also includes processor 408, which may be an application-specific integrated circuit (“ASIC”), or other chipset, logic circuit, or other data processing device. Processor 408 may execute an application programming interface (“API”) (not shown in FIG. 2) that interfaces with any resident programs, such as digitized file processing module 410 and sub-routines associated therewith or the like stored in the memory 406 of the computing apparatus 402.

Processor 408 may include various processing subsystems (not shown in FIG. 2) embodied in hardware, firmware, software, and combinations thereof, that enable the functionality of computing apparatus 402 and the operability of the communication apparatus 402 on distributed computing network 200. For example, processing subsystems allow for initiating and maintaining communications and exchanging data with other networked devices. For the disclosed aspects, processing subsystems of processor 408 may include any subsystem used in conjunction with digitized file processing module 410 and related sub-routines, algorithms, sub-algorithms, modules, sub-modules thereof.

Computer platform 404 may additionally include a communications module (not shown in FIG. 2) embodied in hardware, firmware, software, and combinations thereof, that enables electronic communications between the computing apparatus 700 and computing apparatus 300 and 500 (shown in FIG. 1). Thus, communication module may include the requisite hardware, firmware, software and/or combinations thereof for establishing and maintaining a network communication connection.

Memory 406 of communication device 200 stores digitized file processing module 410, which is configured to authenticate, validate and process digitized files, in accordance with embodiments of the present invention. As previously discussed in relation to FIG. 1, the digitized file processing module 410 is configured to receive digitized files 412 from entities/users 300. The digitized files 412 include one or more sub-files/documents 414 that require processing by the module 410. The digitized file 412 may include other ancillary sub-files/documents that do not require processing by the trusted entity 400 but may be required by the intended recipient. For example, the ancillary sub-files/documents may include photo images or the like.

The digitized file processing module is configured to determine one or more security levels 416 for at least one of the entity/user 300, the sub-file/document 414 and/or the recipient 500. In this regard, one security level 416 may be determined for any combination of the entity/user 300, the sub-file/document 414 and/or the recipient 500. While in other embodiments of the invention, individual security levels 416 may be determined for each of the entity/user 300, the sub-file/document 414 and the recipient 500, where applicable. The security level defines the level of validation/verification required for verifying the identity of the entity/user 300, verifying the validity of the attributes 454 inserted into the sub-files/documents 414, verifying the validating of the intended recipient 500. For example, if the entity/user 300 is determined to have a low security level 416 and/or the sub-file/document 414 has a low security level, minimal attributes may be needed to be verified in order to validate the identity of the entity/user 300. However, if the entity/user 300 and/or sub-file/document 500 is determined to have a high security level, a more significant amount of attributes may be needed to be verified in order to validate the identity of the entity/user 300. The determination of the security level 416 of the entity/user 300 may be made by accessing the entity/user database 450 to retrieve the entity/user profile, which may be configured to include the entity/user's security level. The determination of the security level 416 of the recipient 500 and/or sub-file/document 414 may be made by accessing the validated recipient database 460 to retrieve the validated recipient profile, which may be configured to include the recipient's security level and/or the security level of the validated sub-files/documents 414 associated with the validated recipient 500. In instances where a conflict may arise between the security level of the entity/user 300, the sub-file/documents 414 and the recipient 500, the module may be configured to apply the highest security level 416 or resolve the conflict according to predetermined rules (e.g., the security level 416 of the sub-file/document takes precedent or the like).

Digitized file processing module 410 is further configured to verify the identity 418 of the entity/user or, in some embodiments, as discussed infra. a proxy 427 designated by the entity/user. As previously discussed, the verification of the identity of the user is conducted so as to meet requirements of the security level associated with the entity/user and/or the sub-file/documents 414 and/or the recipient 500. In accordance with embodiments of the invention, the module 410 is configured to access the entity database (450 shown in FIG. 1), via the distributed computing network 200, to verify the identity of the entity/user (or proxy) based on confirming that one or more attributes 454, as defined by the security level 416, in the entity profile 452 match inputs provided by the entity/user 300 (or proxy 427).

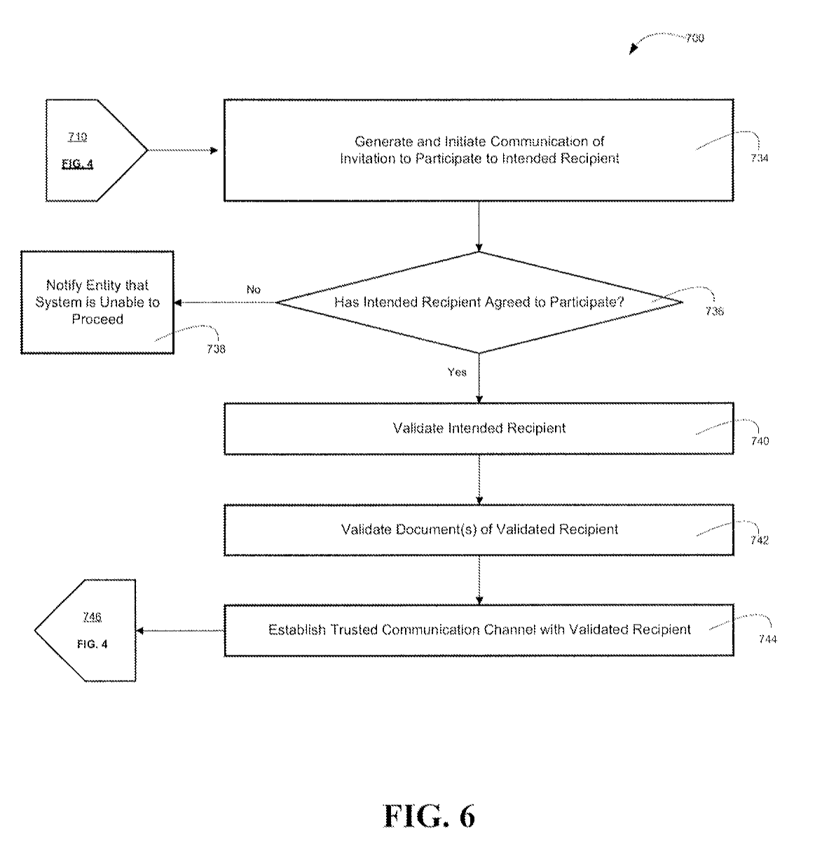

Moreover, in specific embodiments of the invention, the digitized file processing module 410 is further configured to verify 419 that the one or more intended recipients of the sub-file(s)/document(s) are validated recipients and/or that the sub-files/documents 414 are validated sub-files/documents 414. In this regard, the module 410 is configured to access the validated recipient database 460 (shown in FIG. 1), via the distributed computing network 200, to verify that the recipient profile 421 indicates that the intended recipient(s) are validated recipients and, in some embodiments, that the sub-file(s)/documents 414 are validated documents 454. In the event that an intended recipient is not validated and/or a sub-file/document has not previously been validated, the module 410 provides for a sub-process (described infra. in relation to FIG. 6) for validating 440 a new recipient and/or validating new sub-file/document 442 (i.e., validating in response to the intended recipient indicates a willingness to participate in the digitized file processing system).

In specific embodiments of the invention, the module 410 may include logic to verify that pre-conditions 425 are met before proceeding with further processing. Pre-conditions may be related to the sub-file/document 414 and/or specific entry fields of the sub-file document. For example, the sub-file/document 414 may be an automobile rental contract that requires that the entity/user 300 have a currently valid driver's license or the sub-file/document 414 may be registration that requires the entity/user 300 to be a minimum age. In another example, the sub-file document 414 may be a loan application that requires the entity/user to have a minimal amount of assets to apply for the loan. The module 410 may access the entity database 450 or other ancillary databases (shown in FIG. 1) to determine whether the entity/user 300 meets the pre-conditions. In the event, that a user does not meet the pre-conditions and the user has identified/authorized a proxy 427 (or under signer) in their entity/user profile or elsewhere, the proxy 427 may be used instead of the entity/user 300 for purposes of processing one or more of the sub-file(s)/document(s) 414. In such embodiments of the invention, the module 410 may be further configured to notify the proxy/under signer 427 and, in some embodiments, process the sub-file/document 414 in response to receiving authorization from the proxy/under signer 427 and verifying the identity of the proxy/under signer.

In response to verifying the identity of the entity/user and, in some embodiments, verifying that the intended recipient is a validated recipient and/or the sub-file(s)/document(s) are validated sub-file(s)/documents, the module 414 is configured to process 420 the sub-files/documents 414 in accordance with the determined security level(s) 416. In specific embodiments of the invention, processing 420 the sub-file(s)/document(s) 414 includes accessing the entity/user database 450 (shown in FIG. 1) to retrieve attributes 454 from the associated entity profile that correspond to entry fields 422 in the sub-files(s)/document(s) 414 and inserting the attributes 454 in the entry fields 454.

In response to inserting the attributes 454 in the entry fields 422 (or in some embodiments prior to inserting the attributes 454 in the entry fields 422), the module 410 may be configured to verify the validity 424 of attributes 454 to insure their correctness. Such verification may involve accessing the entity/user database 450 (shown in FIG. 1) or some other ancillary database that provides verifying information. In specific embodiments of the invention, the entity/user database is configured to receive data feeds on a continuous or ongoing basis from various data sources to insure that the attribute data 454 in an entity/user profile 452 is up-to-date (dynamically reflects changes to attributes as they occur or as they are made public). In other specific embodiments of the invention, the module 454 is configured to perform quality control 426 on the attributes 454 and the sub-file/documents 414 to insure that the correct attributes 454 are inserted in the correct entry fields 422 and the like.

In response to validating the attributes 424 and performing requisite quality control processing 426, the module 420 may be configured to, optionally, generate and attach to one or more of the sub-files/documents a virtual notarization seal 428 that attests to at least one of the identity 418 of the entity/user 300 and/or proxy 427 and/or the validity 424 of the attributes 454. The virtual notarization seal 428 may be an actual electronic marking on the sub-file/document, for example, an insignia, a watermark or the like, or, where applicable, indicate a notary identification or the like.

Further, in those instance in which one or more of the sub-file(s)/documents require transfer of resources 430 to the intended recipient 500 (e.g., transfer of funds associated with a registration fee, or the like), the module 410 may be configured to determine the amount of resources due and initiate transfer of the resources to the recipient. In such embodiments of the invention, the transfer of resources may occur at a designated time and may be queued so as to occur proximate in time to the date on which the resources become due (e.g., queued such that transferred of resources occur so as to coincide with receipt of the resources by the recipient on the day that that the resources are due).

In response to completion of the processing of the sub-files/documents, the module 410 is configured to initiate communication 432 of the processed sub-file(s)/document(s) 410 to the intended recipient(s) 500. As previously discussed, the intended recipient 500 is a validated recipient and, as such, a trusted communication channel is established between the trusted entity 400 and the validated recipient 500 to insure the security of the sub-files/documents while in transmission.

In further specific embodiments of the invention, the module 410 is configured for recurring processing 444, in which, the module recognizes that certain sub-files/documents 414 require processing on recurring basis, i.e., a predetermined schedule 446, such an monthly, annually or the like. In such instances, the module 410 is configured to call-up and process the sub-file/document 414 proximate to the due date and, in those instances in which the sub-file/document requires such, process resource transfer, in accordance with the resource transfer requirements. In this regard, the module 410 is configured to access a recurring processing database that stores documents that require recurring processing and determine which sub-files/documents require processing based on the respective document's predetermined processing schedule 446.

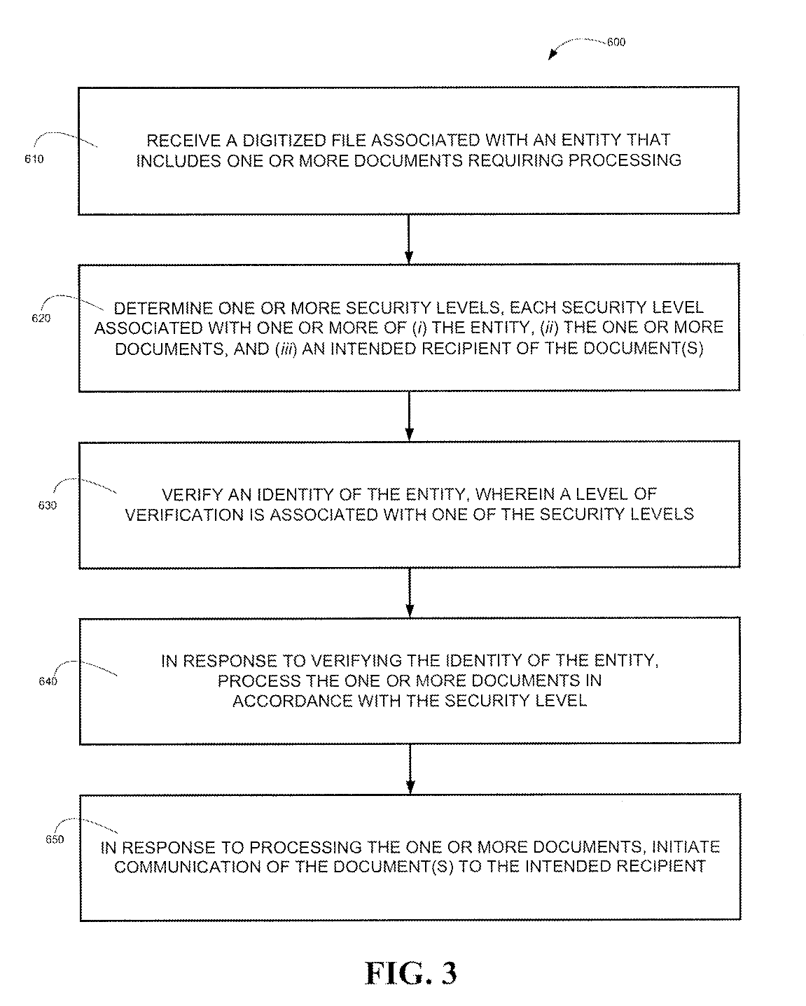

Referring to FIG. 3 a high level flow diagram is presented of a method for automated authentication, validation and processing of digitized files, in accordance with embodiments of the present invention. At Event 610, a digitized file associated with an entity/user is received/ingested by the processing system. The digitized file includes one or more sub-files/documents that require processing, i.e., pre-processing prior to submission to an intended recipient. For example, the sub-files/documents may comprise registration documents, contract documents, application documents, or the like. At Event 620, in response to receiving the digitized files from the entity/user, reading the contents of the file and determining intended recipients, at least one security level is determined for one or more of the entity/user, the sub-files/documents included in the digitized file and/or the intended recipient(s) of the digitized files. As previously discussed the security level defines the level of processing and security measures that are to be implemented in verifying the identity of the entity/user and/or processing the sub-files/documents.

At Event 630, the identity of the entity is verified in accordance with a determined security level. Specifically embodiments of the invention provide for accessing an entity database that stores identity profiles that include attributes associated with the entity/user (i.e., attributes associated with the entity, such as name, address, social security numbers, passwords, biometric data and the like). The attributes in the entity/user profiles are compared to attributes inputted/provided by the entity/user to verify the identity of the entity/user.

At Event 640, in response to verifying the identity of the entity/user, one or more of the sub-files/documents in the digitized file are processed according to one or more of the security levels and, at Event 650, in response to completion of the processing, secured transmission/communication of the sub-file(s)/document(s) to the intended recipients is initiated.

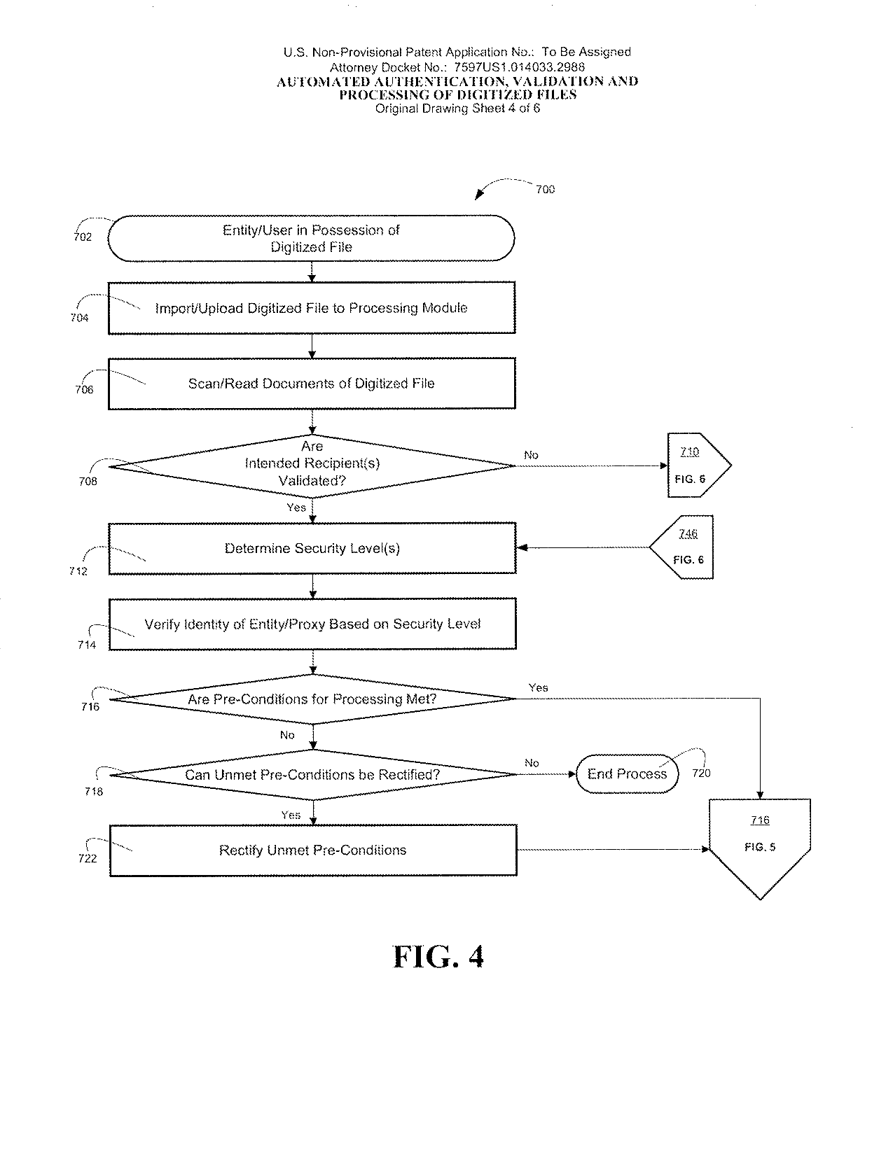

Referring to FIGS. 4-6 a more detailed flow diagram is presented that highlights optional methodology 700 for automated authentication, validation and processing of digitized files, in accordance with embodiments of the present invention. Referring to FIG. 4, at Event 702, an entity/user is in possession of a digitized file that includes one or more sub-file(s)/document(s) that require processing; i.e., pre-processing prior to submission of the sub-files/documents to an intended recipient for application, registration or the like. In the event that the Entity/user possesses the file or sub-files/documents in a non-digitized form, the entity/user may scan the file/sub-files documents or otherwise place the file in digitized format.

At Event 704, the digitized files are imported/uploaded to the processing module/system and, at Event 706, the contents of the digitized file, i.e., the sub-file(s)/documents are scanned/read to identity the sub-file(s)/documents and the intended recipient(s) of the sub-file(s)/document(s). It should be noted that a sub-file/document may be intended for more than one recipient and each sub-file/document may be intended for different recipients. The intended recipients may be read from the sub-files/documents or alternatively, the entity/user may input the intended recipients.

At Decision 708 a determination is made as to whether each of the intended recipients are validated recipients (or alternatively whether each of the sub-files/documents are validated sub-files/documents). Such a determination is made by accessing a validated recipient database to determine whether the intended recipient(s) is/are listed in the database and/or whether the sub-file(s)/document(s) are listed in the database (or an alternate database) as being validated. Recipient validation and/or sub-file/document validation means the recipient and/or sub-file/document has been verified for inclusion in the processing system and secure communication channel has been established with the recipient for transmission of processed files/sub-files/documents. In the event, that one or more intended recipients are determined to not be validated, an attempt is made to validate the intended recipient. Such processing is detailed in FIG. 6 and will be discussed infra.

In response to determining that the intended recipient(s) is/are validated and/or the sub-file(s)/document(s) is/are validated, at Event 712, one or more security levels are determined for at least one of the entity/user, the sub-files/documents and/or the intended recipients. The security level may be determined based on accessing profiles associated with the entity/user and/or the intended recipient and/or the sub-files/documents. As previously discussed the security level(s) will mandate the level of security that needs to be applied to the verification of the identity of the entity/user and/or the processing of the sub-files/documents.

At Event 714, the identity of the entity/user is verified in accordance with a determined security level. In this regard, the security level defines the attributes that a user must provide (e.g., name, password, biometrics and the like) and that need to be matched with corresponding attributes stored in an entity profile in order for the identity of the entity/user to be verified. Typically, the lower the security level the less attributes are required for identity verification and the higher the security level the more attributes are required for identity.

At Decision 716, a determination is made as to whether pre-conditions are met for processing the sub-files/documents. As previously noted the entry fields in the sub-files/documents may have identify pre-conditions or pre-conditions may be designated in validated recipient/validated sub-file/document profiles. For example, if the sub-file is a registration document, the registration process may have requirements/pre-requisites for registering (e.g., possession of a valid instrument, minimum age or the like) or if the sub-file is an application, the application process may have requirements/pre-requisites for applying (e.g., minimal resources available and the like). In determining whether pre-conditions are met, the process may access entity/user profiles or other databases to insure that pre-conditions are met. In the event that pre-conditions are determined to not be met, at Decision 718 a determination is made as to whether the unmet pre-conditions can be rectified. If the unmet pre-conditions cannot be rectified, at Event 720, the entity/user is notified that no further processing will occur. If a determination is made that the unmet pre-conditions can be rectified, at Event 722, the unmet pre-conditions are rectified. In specific embodiments of the invention, unmet pre-conditions may be rectified by assigning a designated proxy or under signer to the sub-files/documents. The designated proxy or under signer may be defined in the entity/user profile or inputted by the entity/user upon file submission or upon notification that a pre-conditions is unmet. In the event that a designated proxy or under signer is assigned to a sub-file/document, the designated proxy/under signer may be notified and requisite verification of the identity of the proxy/under signer occurs based on the security level of the proxy/under signer, the sub-file(s)/document(s) and/or the intended recipient.

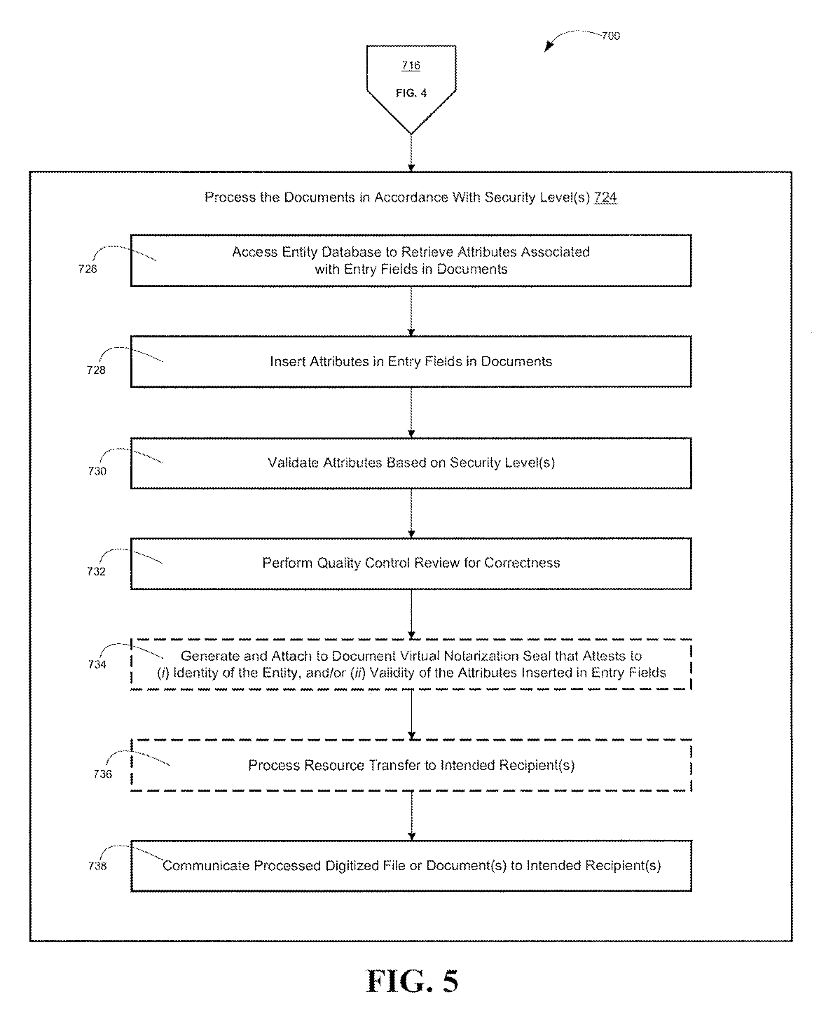

Referring to FIG. 5, at Event 724, in response to verifying the identity of the entity/user (or proxy/under signer), verifying that the intended recipient(s) are validated and that pre-conditions are met, the sub-file(s)/document(s) are processed in accordance with the security level(s). In specific embodiments of the invention, processing includes one or more of the following steps. At Event 726, the entity database is accessed to retrieve attributes associated with corresponding entry fields in the sub-file(s)/document(s) and, at Event 728, the retrieved attributes are inserted in the corresponding entry fields in the sub-file(s)/document(s). At Event 730, the attributes are verified based on the security level. Verification may entail accessing the entity database or other internal or external verification sources to insure that the attributes are accurate. The higher the security level the more comprehensive the verification. For example, a higher security level may require that the attribute be verified at different verification sources or the like. At Event 732, a quality control review is implemented to insure that the correct attributes have been properly entered in the correct entry fields.

Further, according to alternate embodiments of the invention, a determination may be undertaken to determine which sub-files/documents and/or attributes are required by the intended recipients. In this regard, only those sub-files/documents that required by an intended recipient are sent to the recipient and/or only those entry fields that contain attributes that are required by the recipient are processed (i.e., inserted with a corresponding attribute). As such, information is disseminated to the recipients only on a need-to-know basis.

At optional Event 734, one or more virtual notarization seals are generated and attached to one or more of the sub-file(s)/document(s). The notarization seal attests to at least one of (1) the identity of the entity/user and/or, where applicable, the proxy and/or (2) the validity of the attributes. The virtual notarization seal may be an actual electronic marking on the sub-file/document, for example, an insignia, a watermark or the like, or, where applicable, indicate a notary identification or the like.

At optional Event 736, any resource transfers (such as payment of fees and the like) may be automatically processed, i.e., transferred to the intended recipient or other third party. Since in some embodiment s of the invention, the trusted entity that operates or has control over the digitized file processing system is a financial institution, the financial institution is in a position that allows for facilitation of resource transfers.

At Event 738, in response to completion of the processing, the digitized file and/or the sub-file(s)/document(s) are communicated to the validated recipient(s). As previously noted, based on the validation of the recipient, a secured communication channel will have been established between the trusted entity and the validated recipient to insure that transmission of the file and/or sub-file(s)/document(s) occurs in a highly secure manner.

Referring to FIG. 6 a block diagram is presented of a method for validating an intended recipient, in accordance with embodiments of the present invention. At Event 734, in response to determining that an intended recipient is not currently validated, an invitation to participate is generated and communicated to the intended recipient. At Decision 736, a determination is made as to whether the intended recipient has agreed to participate (i.e., responded to the invitation in the affirmative). If the determination is made that the intended recipient has not agreed to participate, at Event 738, the entity that submitted the digitized file is notified that the system is unable to proceed with further processing of the digitized file. If a determination is made that the intended recipient has agreed to participate, at Event 740, the intended recipient is validated and, at Event 742, sub-files/documents associated with the intended/validated recipient are validated. In response to validating the intended recipient and their corresponding sub-file(s)/document(s), at Event 744, a trusted communication channel is established between the trusted entity operating the digitized processing system and the newly validated recipient. In response to validating the new recipient and establishing the trusted communication channel, the process returns to Event 712 of FIG. 4 for further processing of the digitized file.

Thus, systems, apparatus, methods, and computer program products described above provide for automated authentication, validation and processing of digitized files. Specifically, embodiments of the invention provide for receiving/ingesting digitized files from an entity/user that include one or more sub-files (i.e., documents) that require processing. Security level(s), which define validation and processing requirements are determined for one or more of the entity/user, the sub-files and/or the intended recipients of the sub-files. The identity of the entity/user and the validation of the intended recipient and/or sub-files is/are verified in accordance with the determined security level. In response to verifying the identity of the entity/user and/or the verifying the validation of the intended recipient(s) and sub-files, the sub-files are processed according to the determined security levels.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for automated authentication, validation and processing of digitized files, the system comprising:
a distributed computing network;
an entity database in communication with the distributed computing network and configured to store a plurality of entity profiles that include attributes associated with the entity;
a first computing apparatus in communication with the distributed computing network and including a memory and at least one processing device;
a digitized file processing module stored in the memory, executable by the least one processing device and configured to:
receive, via the distributed computing network, a digitized file associated with an entity and comprising one or more documents requiring processing;
determine a security level associated with at least one of the entity, the one or more documents and an intended recipient of one or more documents;
access the entity database, via the distributed computing network, to verify an identity of the entity based on an entity profile associated with the entity including one or more of the attributes required by the security level;
in response to verifying the identity of the entity, process the one or more documents in accordance with the security level; and
in response to processing the one or more documents, communicate the one or more documents to the intended recipient; and
a plurality of second computing apparatus in trusted communication the first computing apparatus, via the distributed computing network, each second computing apparatus associated with one of a plurality of document recipients and configured to receive one or more documents associated with the document recipient.

2. The system of claim 1, further comprising a validated document recipient database in communication with the distributed computing network and configured to store a plurality of document recipient profiles that include one or more verified documents.

3. The system of claim 2, wherein the digitized file processing module is further configured to access the validated document recipient database to verify at least one of (1) the intended recipient of the one or more documents is a validated document recipient and (2) the one or more documents are validated documents.

4. The system of claim 3, wherein the digitized file processing module is further configured to initiate validation of a document recipient in response to a determination that the intended recipient is not currently a validated document recipient.

5. The system of claim 1, wherein the digitized file processing module is further configured to determine that one or more of the documents should be processed for a proxy of the entity.

6. The system of claim 1, wherein the digitized file processing module is configured to process the one or more documents by accessing the entity database, via the distributed computing network, to retrieve attributes associated with entry fields in the one or more documents and insert the attributes in the entry fields.

7. The system of claim 6, wherein the digitized file processing module is further configured to determine at least one of (1) which of the one or more documents are required by the intended recipient and (2) which of the attributes inserted in the entry fields are required by the intended recipient, and, in response to determining at least one of (1) and (2), insure that only at least one of required documents and required attributes are communicated to the intended recipient.

8. The system of claim 6, wherein the digitized file processing module is further configured to access at least one of the entity database or an ancillary database to validate the attributes inserted in the entry fields in accordance with the security level.

9. The system of claim 5, wherein the digitized file processing module is further configured to generate and attach to at least one of the one or more documents a virtual notarization seal, wherein the virtual notarization seal attests to at least one of (1) the identity of the entity and (2) the validity of the attributes inserted into the entry fields.

10. The system of claim 1, wherein the digitized processing module is configured to process the one or more documents by accessing the entity database, vi the distributed computing network, to determine that one or more pre-conditions are met, wherein meeting the pre-conditions are a prerequisite for further processing.

11. The system of claim 1, wherein the digitized file processing module is further configured to determine that at least one of the one or more documents require recurring processing and automatically process the one or more documents on a recurring basis, wherein the recurring basis is based on a predetermined processing schedule.

12. The system of claim 1, wherein the digitized file processing module is further configured to determine an amount of resources associated with the one or more documents and transfer the resources to the intended recipient.

13. The system of claim 1, further comprising an attribute update module stored in memory, executable by the at least one processing device and configured to receive one or more data feeds on an ongoing basis, wherein the data feeds include information associated with the attributes stored in the entity profiles, determine that the information reflects a change in the attributes and access the entity database to update the attributes in the entity profiles to reflect the change.

14. An apparatus for automated authentication, validation and processing of digitized files, the apparatus comprising:
a computing platform including a memory and at least one processing device stored in the memory; and
a digitized file processing module stored in the memory, executable by the least one processing device and configured to:
receive a digitized file associated with an entity and comprising one or more documents requiring processing;
determine a security level associated with at least one of the entity, the one or more documents and an intended recipient of one or more documents;
verify an identity of the entity, wherein a level of verification is associated with the security level;
in response to verifying the identity of the entity, process the one or more documents in accordance with the security level; and
in response to processing the one or more documents, initiate communication of the one or more documents to the intended recipient.

15. The apparatus of claim 14, wherein the digitized file processing module is further configured to verify at least one of (1) the intended recipient of the one or more documents is a validated document recipient, and (2) the one or more documents are validated documents.

16. The apparatus of claim 15, wherein the digitized file processing module is further configured to initiate validation of a document recipient in response to a determination that the intended recipient is not currently a validated document recipient.

17. The apparatus of claim 14, wherein the digitized file processing module is configured to process the one or more documents by retrieving attributes associated with entry fields in the one or more documents and inserting the attributes in the entry fields.

18. The apparatus of claim 14, wherein the digitized file processing module is further configured to determine that at least one of the one or more documents require recurring processing and automatically process the one or more documents on a recurring basis, wherein the recurring basis is based on a predetermined processing schedule.

19. A computer program product for automated authentication, validation and processing of digitized files, the computer program product comprising:
a non-transitory computer-readable medium comprising a set of codes for causing at least one computer to:
receive a digitized file associated with an entity and comprising one or more documents requiring processing;
determine a security level associated with at least one of the entity, the one or more documents and an intended recipient of one or more documents;
verify an identity of the entity, wherein a level of verification is associated with the security level;
in response to verifying the identity of the entity, process the one or more documents in accordance with the security level; and
in response to processing the one or more documents, initiate communication of the one or more documents to the intended recipient.

20. The computer program product of claim 19, wherein the set of codes further cause the at least one computer to verify that at least one of (1) the intended recipient of the one or more documents is a validated document recipient, and (2) the one or more documents are validated documents.
